(19) United States
(12) Patent Application Publication
(10) Pub. No.: US 2011/0222925 A1
(43) Pub. Date: Sep. 15, 2011

(54) FIXING DEVICE, IMAGE FORMING APPARATUS AND FIXING METHOD

(75) Inventor: Shuji YOKOYAMA, Tokyo (JP)

(73) Assignees: Kabushiki Kaisha Toshiba, Tokyo (JP); Toshiba Tec Kabushiki Kaisha, Tokyo (JP)

(21) Appl. No.: 13/015,419

(22) Filed: Jan. 27, 2011

Related U.S. Application Data
(60) Provisional application No. 61/312,037, filed on Mar. 9, 2010.

(30) Foreign Application Priority Data
Sep. 13, 2010 (JP) 2010-203976

(51) Int. Cl. G03G 15/20

(52) U.S. Cl. 399/328

(57) ABSTRACT

According to one embodiment, fixing device includes a first heat roller to generate heat, a second heat roller to generate heat and fix a toner image formed on a recording medium passing through a nip between the first heat roller and the second heat roller, and a unitary heating unit provided to heat the first heat roller and the second heat roller, the heating unit being provided with a passage to pass the recording medium in a position opposing the nip.

### CROSS-REFERENCE TO RELATED APPLICATION

This application is based upon and claims the benefit of priority from the prior U.S. Patent Application No. 61/312,037 filed on Mar. 9, 2010, the entire contents of which are incorporated herein by reference.

This application is also based upon and claims the benefit of priority from Japanese Patent Application No. 2010-203976, filed on Sep. 13, 2010, the entire contents of which are incorporated herein by reference.

### TECHNICAL FIELD

Exemplary embodiments described herein relate to fixing devices, image forming apparatuses and fixing methods in the image forming apparatuses.

### BACKGROUND

In General, fixing devices in the image forming apparatuses such a copy machine and a printer using electro-photography are provided with a heat roller heated by a heating method, and the pressure roller welded by pressure to a heat roller with prescribed pressure. By passing the unfixed recording medium on which the toner image was transferred in the transferrer residing upstream the fixing device through the nip, between the heat roller and the pressure roller, the unfixed toner image is fixed on the recording medium by being heated.

In this kind of fixing device, there are some which employ a heat source of induction hearing system to heat the heat roller by magnetic field generated from an induction heater disposed near the heat roller.

Further, there is known another fixing device to heat the pressure roller, in which a heat source other than the heat source to heat the heat roller is provided for the pressure roller. As the heat source for the pressure roller, a halogen lamp or an induction heater like the induction heater to heat the fixing roller can be used.

However, when another heat source different from the heat source is provided for the pressure roller, the number of components of the fixing device increases, there arises a fear that the construction of the fixing device becomes complicated.

### BRIEF DESCRIPTION OF THE DRAWINGS

FIG. 1 is a perspective view of an image forming apparatus;

FIG. 2 is a perspective view of a fixing device in Embodiment 1;

FIG. 3 is a sectional view of the fixing device;

FIG. 4 is a perspective view of a fixing device in Embodiment 2; and

FIG. 5 is a layout drawing of ferrite cores in Embodiment 2.

### DETAILED DESCRIPTION

In general, according to one embodiment, there is provided a fixing device including, a first heat roller to generate heat, a second heat roller to generate heat and fix a toner image formed on a recording medium passing through a nip between the first heat roller and the second heat roller, and a unitary heating unit provided to heat the first heat roller and the second heat roller, the heating unit being provided with a passage to pass the recording medium in a position opposing the nip.

Hereinafter, one embodiment of the present invention will be described with reference to drawings.

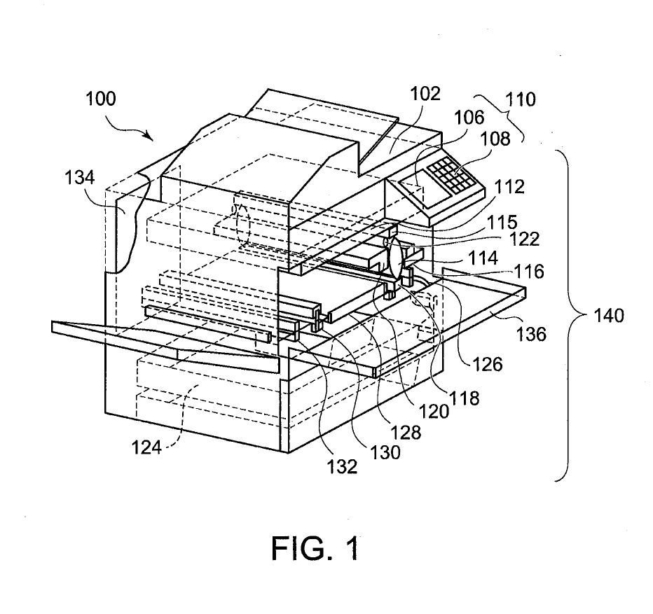

(Embodiment 1) Embodiment 1 will be described with reference to FIG. 1 through FIG. 3. FIG. 1 is a perspective view of the image forming apparatus 100. The image forming apparatus 100 is provided with an image reader 102 which reads an original image as of a reading object, and an image forming portion 140 which forms the read image on the recording medium, such as a paper. On top of the image forming apparatus 100, there is an operation panel 110 which includes a display 106 with touch panel and various kinds of operation keys 108.

The operation keys 108 on the operation panel 110 includes, for example, numeric keys, a reset key, a stop key, a start key, etc. On the display 106, input operations for various types of handling, such as a paper size setting, setting a number of copy, a printing density setting, and a binding, are performed.

The image forming portion 140 is provided with a laser unit 112, a photoconductor 114 which is comprised of a rotary drum, a charger 115, a developer 116, a transferrer 118, a cleaner 120, and a charge eliminator 122. The image forming apparatus 100 is further provided with a sheet feeder 124, a conveying path 126, a conveyor belt 128, a fixing device 130, an exit roller 132, an electric circuit board 134, and a maintenance service door 136. Each component of the image forming device 100 is a conventionally well-known component, except for the fixing device 130.

Hereinafter, an outline of the image forming operation which the image forming apparatus 100 performs will be explained. The charger 115 charges the periphery of the rotating photoconductor 114. The laser unit 112 forms an electrostatic latent image on the periphery of the charged photoconductor 114, based on the original image read by the image reader 102, as described above. The developer 116 makes toner adhere to the electrostatic latent image, and develops the latent image to a toner image. The transferrer 118 transfers the toner image on the recording medium, i.e., a paper P conveyed from the sheet feeder 124 through the conveying path 126. The cleaner 120 removes the toner remaining on the photoconductor 114, without being transferred. Then, the charge eliminator 122 removes the residual charges on the periphery of the photoconductor 114, and restores initial state.

The conveyor belt 128 conveys the paper P on which the toner image has been transferred to the fixing device 130. The fixing device 130 fixes the toner image on the paper P. The exit roller 132 discharges the paper P on which the toner image has been fixed, from the image forming apparatus 100.

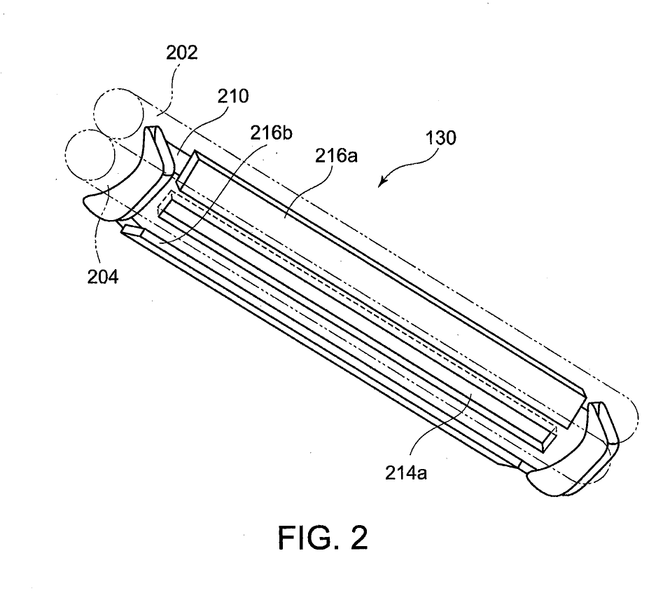

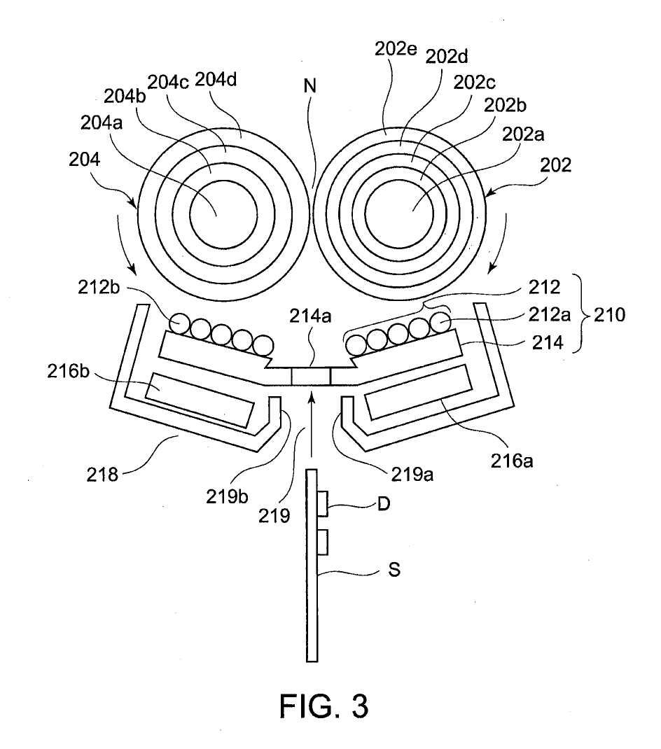

FIG. 2 is a perspective view of the fixing device 130 in this Embodiment 1. FIG. 3 is a sectional view of the fixing device 130

The fixing device 130 has a heat roller 202 and a pressure roller 204, and fixes the toner image on the paper P.

The heat roller 202 contacts to one surface of the paper P, on which surface a toner image D has been transferred, and heat the toner image D. The heat roller 202 rotates in the direction of the arrow as shown in the drawing FIG. 2. The heat roller 202 is comprised of a cored bar 202a, a foamed rubber layer 202b, a metallic conductive layer 202c, a hard rubber layer 202d, and a mold release agent layer 202e, which are sequentially arranged in the order from inside the heat roller 202. For example, the foamed rubber layer 202b has a thickness of 5 mm. The metallic conductive layer 202c has a thickness of 50 micrometer. The hard rubber layer 202d has a thickness of 200 micrometer. The mold release agent layer 202e has a thickness of 30 micrometer. The metallic conductive layer 202c is formed with nickel, stainless steel, aluminum, or a composite material of stainless steel and aluminum, etc.

The pressure roller 204 contacts to the other surface of the paper P opposite to the surface with the transferred toner image. A well-known pressurizing mechanism (not shown) presses the pressure roller 204 against the heat roller 202, and forms a nip N between the pressure roller 204 and the heat roller 202. The pressure roller 204 is driven rotated by the heat roller 202. The heat roller 202 and the pressure roller 204 rotate in nipping the paper P on which the toner image D has been formed in the nip N to fix the toner image D on the paper P. The pressure roller 204 has a cored bar 204a, a metallic conductive layer 204b, a rubber layer 204c, and a mold release agent layer 204d, which are sequentially arranged in the order from inside the pressure roller 204. The metallic conductive layer 204b is formed, for example, with nickel, stainless steel, aluminum, or a composite material of stainless steel and aluminum, etc. like the heat roller 202.

The induction heater 210 is comprised of a litz wire coil 212 and a magnetic core 214. The magnetic core 214 is defined a slit 214a through which the paper P passes, i.e., a recording medium passage hole.

A litz wire of the litz wire coil 212 is, for example, a conducting-wire material which is a twisted thin wire insulated with heat tolerance polyamide-imide resin, etc. The litz wire coil 212 is wound on the magnetic core 214. The litz wire coil 212 is wound on the both sides of the magnetic core 214, which is separated via a slit 214a used, as a passage to pass a recording medium, and thus forms respective induction heaters on both sides of the magnetic core.

The litz wire coil 212 will generate magnetic flux, when a high frequency current is applied. By the magnetic flux generated by the litz wire coil 212, another magnetic flux and an eddy current occur in the metallic conductive layer 202c of the heat roller 202, and the metallic conductive layer 204b of the pressure roller 204, respectively, so as to eliminate the variation of magnetic field of the litz wire coil 212. With the electric resistance of the metallic conductive layers 202c and 204b against the eddy current, Joule's heat occurs in the metallic conductive layers 202c and 204b themselves, and thus the heat roller 202 and the pressure roller 204 generate heat.

Now, a physical relationship between the induction heater 210 and the heat roller 202, and also a physical relationship between the induction heater 210 and pressure roller 204 will be explained.

The slit 214a of the induction heater 210 faces the nip N between the heat roller 202 and the pressure roller 204. The litz wire coil 212a on the one side of the induction heater 210 which is separated by the slit 214s faces the heat roller 202, while the litz wire coil 212b on the other side of the induction heater 210 faces the pressure roller 204.

The heat roller 202 and the pressure roller 204 generate heat by receiving magnetic induction respectively applied from the litz wire coils 212a and 212b which the rollers are facing, respectively. That is, the heat roller 202 and the pressure roller 204 will be simultaneously heated by the unitary induction heater 210.

The ferrite cores 216a are disposed on a location facing the heat roller 202 through the induction heater 210, while the ferrite, cores 216b are disposed on another location facing the pressure roller 204 through the induction heater 210. The ferrite cores 216a and 216b order the magnetic flux generated by the induction heater 210, and apply the magnetic flux effectively to the heat roller 202 and the pressure roller 204. Thus, by providing the ferrite cores 216a and 216b, the magnetic flux generated by the induction heater 210 is applied efficiently to the heat roller 202 and the pressure roller 204.

Since there arises a fear that fault may occur in peripheral equipments around the heat roller 202 and the pressure roller 204, especially in the induction heater 210, a cover 218 made of heat-resisting resin is provided for the induction heater 210 As shown in FIG. 3, except for the portion which faces the heat roller 202 and the pressure roller 204. The cover 218 of the induction heater 210 has the guide 219 which shows the paper P to the nip N of the heat roller 202 and the pressure roller 204.

In the guide 219, the edging portions 219a and 219b of the opening provided in the center portion of the cover 218 elongates along the transportation direction of the paper P. By these elongated edging portions 219a and 219b, the paper P conveyed is guided to the nip N. Thus, it is not necessary to provide additional member, and the construction of the guide 219 can be simplified by the guide 219 to pass the paper P is provided in the cover 218 of the induction heater 210 itself.

According to the embodiment, the heat roller 202 and the pressure roller 204 can be simultaneously heated with the unitary induction heater 210. Therefore, it is not necessary to provide heat sources in each of the heat roller 202 and the pressure roller 204 individually, the number of members becomes fewer, and a construction becomes simple. Since one heat source serves the purpose, it leads also to reduction of cost.

In the embodiment, although the induction heater 210 is provided upstream the heat roller 202 and the pressure roller 204 in the transportation direction of the paper P, the induction heater 210 may be provided downstream the heat roller 202 and the pressure roller 204. Thus, even when the induction heater 210 is provided downstream the heat roller 202 and the pressure roller 204, the heat roller 202 and the pressure roller 204 can be heated. When the induction heater 210 is provided in the downstream of the heat roller 202 and the pressure roller 204 in this way, the guide 219 provided in the cover 218 serves as a conveyance guide in which the paper P carried out the fixing operation is conveyed.

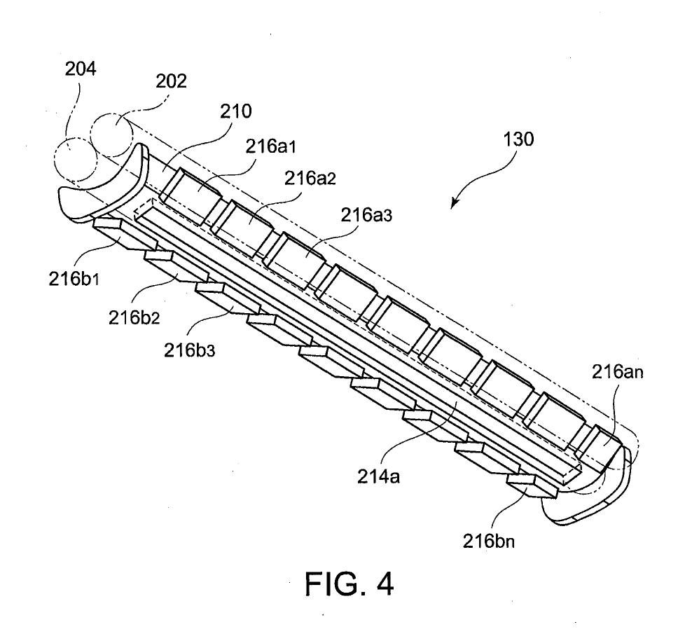

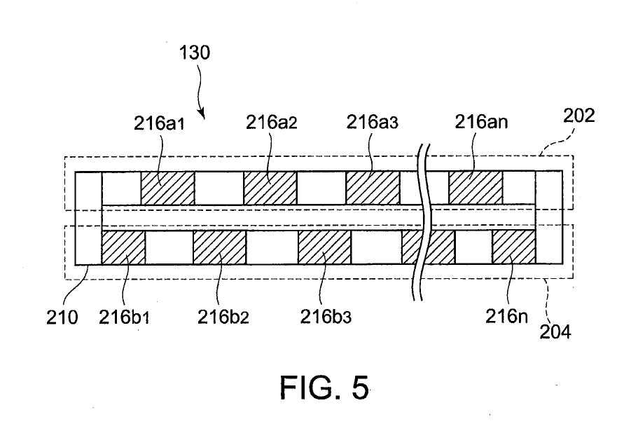

(Embodiment 2) Embodiment 2 will be described with reference to FIG. 4 and FIG. 5.

Hereafter, only the characterizing portion of this Embodiment 2 will be explained by giving same symbols to the same portions of the Embodiment 1.

FIG. 4 is a perspective view of a fixing device in this Embodiment 2.

In the Embodiment 2, a plurality of the ferrite cores 216a1, 216a2, . . . , 216an on location facing the heat roller 202 through the induction heater 210 are arranged along the rotation axis of the heat roller 202 by being spaced with each other. Similarly, a plurality of the ferrite cores 216b1, 216b2, . . . , 216bn on location facing the pressure roller 204 through the induction heater 210 are arranged along the rotation axis of the pressure roller 204 by being spaced with each other.

FIG. 5 is a layout drawing showing the arrangement of the ferrite cores 216a1, 216a2, . . . , 216an, and the ferrite cores 216b1, 216b2, . . . , 216bn, as seeing the fixing device 130 from the upstream of the paper conveying direction. As shown in FIG. 5, the ferrite cores 216a1, 216a2, . . . , 216an facing the heat roller 202 through the induction heater 210 and the ferrite cores 216b1, 216b2, . . . , 216bn facing the pressure roller 204 through the pressure roller 204 are aligned zigzag with each other along the rotation axis of the rollers 202, 204.

Since, in location of the spaces where the ferrite cores in case of unitary row of ferrite cores are separated, magnetic fluxes fail to be ordered, there arises an irregularity in the degree of heating of the heat roller 202 and the pressure roller 204 by the magnetic induction. However, owing to the ferrite cores 216a1, 216a2, . . . , 216an facing the heat roller 202 through the induction heater 210 and the ferrite cores 216b1, 216b2, . . . , 216bn facing the pressure roller 204 through the pressure roller 204 being aligned zigzag with each other along the rotation axis of the rollers 202, 204, a temperature irregularity along the rotation axis can be eliminated.

Since the ferrite core is expensive, it is desirable to reduce the area which provides a ferrite core. As described above, when the plurality of ferrite cores 216a1, 216a2, . . . , 216an on one side and the plurality of ferrite cores 216b1, 216b2, . . . , 216bn on the other side are aligned with spaces with each other along the rotation axis of the heat roller 202 and the pressure roller 204, and further the ferrite cores are aligned zigzag with each other along the rotation axis of the heat roller 202 and the pressure roller 204, the area to dispose the ferrite cores can be reduced, without arising the temperature irregularity along the rotation axis of the rollers 202, 204. That is, compared with the conventional fixing device which provided the ferrite core over the overall length of the rotation axis of the heat roller 202 and the pressure roller 204, a very cheap fixing device is realizable.

What is claimed is:

1. A fixing device comprising:
a first heat roller to generate heat;
a second heat roller to generate heat and fix a toner image formed on a recording medium passing through a nip between the first heat roller and the second heat roller; and
a unitary heating unit provided to heat the first heat roller and the second heat roller, the heating unit being provided with a passage to pass the recording medium in a position opposing the nip.

2. The device as claimed in claim 1,
the heating unit including an induction heater;
the first heat roller having a metallic conductive layer which generates heat by a magnetic induction of the induction heater; and
the second heat roller having a metallic conductive layer which generates heat by a magnetic induction of the induction heater.

3. The device as claimed in claim 2,
the induction heater having two parts residing on both sides of a passage to pass the recording medium, the one part opposing the first heat roller to apply magnetic flux to the first heat roller and the other part opposing the second heat roller to apply magnetic flux to the second heat roller.

4. The device as claimed in claim 2, further comprising:
a first sequence of ferrite cores locating in opposite to the first heat roller on one side of the induction heater; and
a second sequence of ferrite cores locating in opposite to the second heat roller on the other side of the induction heater.

5. The device as claimed in claim 4,
a slit serving as the passage to pass the recording medium being defined between the first sequence of ferrite cores and the second sequence of ferrite cores.

6. The device as claimed in claim 4,
the first sequence of ferrite cores including multiple ferrite cores arranged along the rotation axis of the first heat roller; and
the second sequence of ferrite cores including multiple ferrite cores arranged along the rotation axis of the second heat roller.

7. The device as claimed in claim 6,
the multiple ferrite cores in the first ferrite core sequence and the multiple ferrite cores in the second ferrite core sequence are aligned zigzag in cooperation with others.

8. The device as claimed in claim 2, further comprising:
a cover covering the induction heater except portions opposing the first heat roller and the second heat roller.

9. The device as claimed in claim 8,
the cover having a guide portion to guide the recording medium into the passage to pass the recording medium.

10. The device as claimed in claim 2,
the induction heater being in the upstream from the first heat roller about the conveying direction of the recording medium.

11. The device as claimed in claim 1,
the second heat roller being a pressure roller.

12. An image forming apparatus comprising:
a conveying part to convey a recording medium;
an image forming part to form a toner image on the recording medium;
a first heat roller to generate heat;
a second heat roller to generate heat and fix a toner image formed on a recording medium passing through a nip between the first heat roller and the second heat roller; and
a unitary heating unit provided to heat the first heat roller and the second heat roller, the heating unit being provided with a passage to pass the recording medium in a position opposing the nip.

13. The apparatus as claimed in claim 12,
the heating unit including an induction heater;
the first heat roller having a metallic conductive layer which generates heat by a magnetic induction of the induction heater; and
the second heat roller having a metallic conductive layer which generates heat by a magnetic induction of the induction heater.

14. The apparatus as claimed in claim 13,
the induction heater having two parts residing on both sides of a passage to pass the recording medium, the one part opposing the first heat roller to apply magnetic flux to the first heat roller and the other part opposing the second heat roller to apply magnetic flux to the second heat roller.

15. The apparatus as claimed in claim 13, further comprising:
a first sequence of ferrite cores locating in opposite to the first heat roller on one side of the induction heater; and
a second sequence of ferrite cores locating in opposite to the second heat roller on the other side of the induction heater.

16. The apparatus as claimed in claim 15,
a slit serving as the passage to pass the recording medium being defined between the first sequence of ferrite cores and the second sequence of ferrite cores.

17. The apparatus as claimed in claim 15,
the first sequence of ferrite cores including multiple ferrite cores arranged along the rotation axis of the first heat roller; and
the second sequence of ferrite cores including multiple ferrite cores arranged along the rotation axis of the second heat roller.

18. The apparatus as claimed in claim 17,
the multiple ferrite cores in the first ferrite core sequence and the multiple ferrite cores in the second ferrite core sequence being aligned zigzag in cooperation with others.

19. The apparatus as claimed in claim 13, further comprising:
a cover to cover the induction heater except portions facing the first heat roller and the second heat roller

20. An image forming method, comprising;
conveying a recording medium;
forming a toner image on the recording medium;
fixing the toner image formed on the recording medium passing through a nip between a first and a second heat rollers by causing a magnetic induction heating in the first and second heat rollers with a unitary induction heater defined a passage to pass the recording medium conveyed to the nip.
